(19) United States
(12) Patent Application Publication
(10) Pub. No.: US 2025/0031621 A1
(43) Pub. Date: Jan. 30, 2025

(54) COTTON STRIPPER AIR DUCT SYSTEM

(71) Applicant: Deere & Company, Moline, IL (US)

(72) Inventors: Sachin C. BALLEWAR, Chandrapur (IN); Marcus A. JACOBSON, Ankeny, IA (US); Daniel J. JOHANNSEN, Des Moines, IA (US); Jeffrey S. WIGDAHL, Ames, IA (US)

(73) Assignee: Deere & Company, Moline, IL (US)

(21) Appl. No.: 18/768,790

(22) Filed: Jul. 10, 2024

Related U.S. Application Data
(60) Provisional application No. 63/516,318, filed on Jul. 28, 2023.
(60) Provisional application No. 63/516,326, filed on Jul. 28, 2023.
(60) Provisional application No. 63/516,299, filed on Jul. 28, 2023.

(51) Int. Cl. A01D 46/12

(52) U.S. Cl. CPC A01D 46/12

(57) ABSTRACT

One or more techniques and/or systems are disclosed for harvesting cotton that includes an air duct for a cotton stripper having a body having a passageway therethrough, wherein the body has a curved portion. The air duct further includes a plurality of protruding members extending into the passageway, wherein the plurality of protruding members comprises a first type of obstructing members and a second type of obstructing members. The first type of obstructing members is different than the second type of obstructing members, and the plurality of protruding members extend along the curved portion of the body.

### CROSS-REFERENCE TO RELATED APPLICATIONS

The present application is based on and claims the benefit of U.S. Provisional Patent applications Ser. No. 63/516,318, filed Jul. 28, 2023, entitled COTTON STRIPPER AIR DUCT SYSTEM, Docket Number (016529-000168/P34701-US-PRO), Ser. No. 63/516,326, filed Jul. 28, 2023, entitled COTTON STRIPPER AIR DUCT SYSTEM, Docket Number (016529-000170/P34781-US-PRO), and Ser. No. 63/516,299, filed Jul. 28, 2023, entitled COTTON STRIPPER AIR SUPPLY SYSTEM, Docket Number (016529-0166/P34494-US-PRO), the contents of each of which are hereby incorporated by reference herein in their entirety.

### SUMMARY

Harvester vehicles are used to harvest different crops, such as cotton. When using cotton strippers to harvest cotton, the entire cotton boll is harvested from the stalk. During this harvesting process, unripe green bolls are not kept, but are separated out of the harvest when passing into the cotton stripper air duct system. For example, separation components can be used to prevent unwanted material, such as green bolls and rocks, from passing through the air duct system and moving towards the cleaner system of the harvester vehicles. These separation components can reduce the cotton flow rate through the air duct system.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for harvesting crop at a higher flow rate while still removing unwanted or non-desired materials. In one implementation, an air duct for a cotton stripper comprises a body having a passageway therethrough, wherein the body has a curved portion. The air duct further comprises a plurality of protruding members extending into the passageway, wherein the plurality of protruding members comprises a first type of obstructing members and a second type of obstructing members. The first type of obstructing members is different than the second type of obstructing members, and the plurality of protruding members extend along the curved portion of the body.

In any of the implementations, a first protruding member and a last protruding member of the plurality of protruding members are of the first type of obstructing member and all of the protruding members between the first and last protruding members are of the second type of obstructing member.

In any of the implementations, the second type of obstructing member has a height that is greater than a height of the first type of obstructing member.

In any of the implementations, the first type of obstructing members comprises hat-shaped baffles.

In any of the implementations, the second type of obstructing members comprises triangular-shaped baffles.

In any of the implementations, the first type of obstructing members having a first profile height and the second type of obstructing members have a second profile height, wherein the first profile height is different than the second profile height.

In any of the implementations, the plurality of protruding members comprises baffles of varying profile heights.

In any of the implementations, the curved portion of the body comprises a curved rear separation duct panel and the plurality of protruding members are configured to increase in height as a depth of the curved rear separation duct panel increases and decrease in height as the depth of the curved rear separation duct panel decreases.

In any of the implementations, the air duct further comprises a first portion formed from the body and a second portion formed from another body, wherein the first and second bodies have complementary passageways, wherein the first and second portions are mutually coupled having a gap therebetween.

In any of the implementations, the air duct further comprises a sealing member covering the gap.

In any of the implementations, the curved portion of the body is defined by the first and second portions of the air duct.

In any of the implementations, the curved portion of the body defines a generally “S” shaped curve.

In any of the implementations, the generally “S” shaped curve defined by the first and second portions of the air duct are operable to cause sashay movement of cotton as the cotton moves through the body.

In any of the implementations, the generally “S” shaped curve comprises a cotton impingement surface defined in areas of the first and second portions of the air duct adjacent to the gap between the first and second portions.

In any of the implementations, the generally “S” shaped curve comprises a velocity gradient zone in an area of the duct near to the plurality of protruding members.

In any of the implementations, the velocity gradient zone of the generally “S” shaped curve is operable to induce a higher first traveling velocity in cotton as the cotton moves through the body on a side of the air duct opposite from the plurality of protruding members relative to a second traveling velocity induced in cotton that moves through the body on a side of the air duct that supports the plurality of protruding members.

In any of the implementations, the relative difference between the first and second traveling velocities induced by the velocity gradient zone defines an energy vector oriented in a direction extending away from the plurality of protruding members and generally towards a side of the second portion of the air duct adjacent to the cotton impingement surface.

In any of the implementations, the energy vector defined by the velocity gradient zone enhances separation of cotton from bolls and other debris thereby permitting the cotton to move upward in a first direction through the body on a side of the air duct opposite from the plurality of protruding members while also causing the bolls and other debris to move in a second direction opposite from the first direction on the side of the air duct that supports the plurality of protruding members.

In any of the implementations, each member of the plurality of protruding members abuts at least one adjacent member of the plurality of protruding members.

In any of the implementations, each member of the plurality of protruding members is spaced apart from at least one adjacent member of the plurality of protruding members.

In any of the implementations, the body is configured to couple with a cross-auger of a cotton stripper.

In another implementation, a harvester vehicle comprises a header system that includes a crop header component, wherein the crop header components comprises a cotton stripper header. The harvester vehicle further comprises an air system operably coupled to, and in communication with, the header system, wherein the air system comprises a crop conveyor component that conveys crop through the harvester vehicle, and the crop conveyor component includes one or more air ducts having a cotton stripper lower transition duct comprising a curved rear separation panel with a plurality of varying profile height baffles.

In another implementation, a method for configuring a lower transition duct in a cotton stripper comprises configuring a plurality of protruding members to having a first type of obstructing member and a second type of obstructing member and configuring a rear separation duct panel of the lower transition duct to have a curved surface. The method further comprises coupling the plurality of protruding members to the curved surface of the rear separation duct panel, wherein the protruding members extend into a passageway of the lower transition duct.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a harvester vehicle having a cotton stripper according to an implementation.

FIG. 2 is a component diagram illustrating an air flow system with a lower transition duct configured according to an implementation.

FIG. 2A is a component diagram illustrating an air flow system with a lower transition duct configured according to an implementation.

FIG. 3 is a diagram illustrating a portion of a lower transition duct having protruding members according to an implementation.

FIG. 4 is a diagram illustrating protruding members according to an implementation.

FIG. 5 is a perspective view of the protruding members of FIG. 4.

FIG. 6 is a diagram illustrating a curved rear separation duct panel with protruding members according to an implementation.

FIG. 7 is a perspective view of a portion of a lower transition duct having protruding members according to an implementation.

FIG. 8 illustrates an example of a method for configuring a lower transition duct in a cotton stripper according to an implementation.

FIG. 9 is a block diagram of an example computing environment suitable for implementing various examples.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific farm harvester vehicles for particular harvesting applications, such as the herein described cotton harvester).

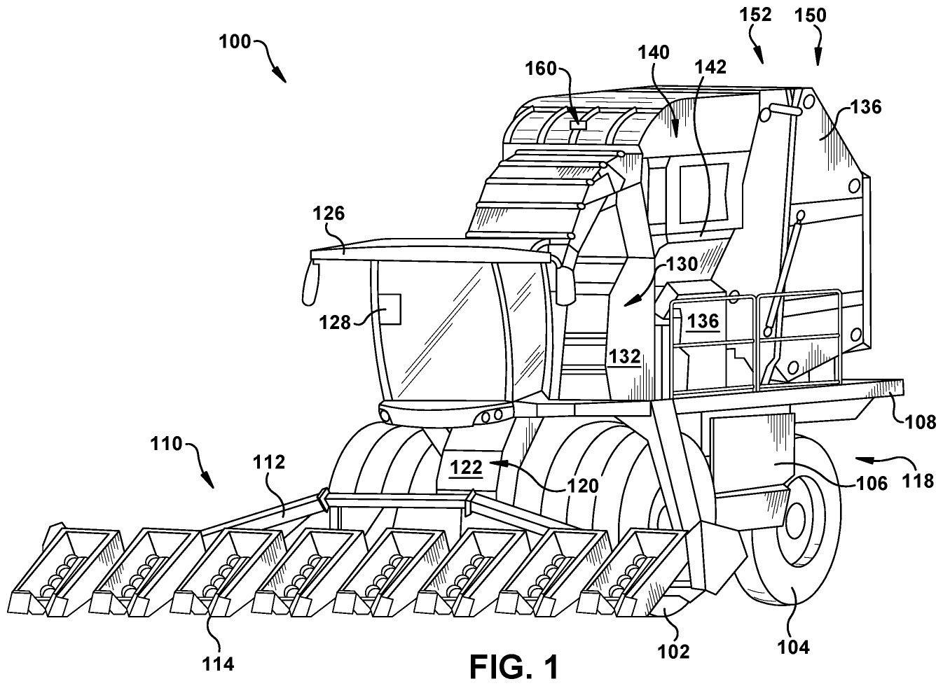

FIG. 1 illustrates an example harvester vehicle 100 that can utilize one or more portions of the aspects and examples described herein to harvest cotton. In this example, the harvester vehicle 100 is a cotton harvester with a cotton stripper, but other types of harvesters are contemplated by this disclosure.

The harvester vehicle 100 includes a chassis 108 that is supported by front wheels 102 and rear wheels 104, although other support is contemplated, such as tracks. A power module 118, such as an engine 106, is supported below the chassis 108 in the illustrated example. Water, lubricant, and fuel tanks (not shown) can be supported in and on the chassis 108. The harvester vehicle 100 is adapted for movement through a field to harvest crops, such as cotton in one or more examples.

An operator station 126 is also supported by the chassis 108. An operator interface 128 is positioned in the operator station 126. In some examples, the operator interface 128 includes or is configured as a controller that allows for controlling the operation or setting of one or more components of the harvester vehicle 100.

A crop harvesting device 114 is coupleable to the chassis 108. The crop harvesting device 114 can be configured to remove cotton from a field in some examples. The crop harvesting device 114 in one or more examples includes a header system 110 having one or more cotton stripper headers 112 operable to strip cotton during harvesting. However, other devices are capable of being coupled to the harvester vehicle, such as one or more cotton picking units, or another harvesting structure (e.g., corn head, or other crop heads). The crop harvesting device 114 has different configurations (e.g., sizes, dimensions, etc.) depending on the type of crop being harvested and the manner of removing the crop from the field. In various herein described implementations, the harvester vehicle 100 is a cotton stripper equipped with the crop harvesting device 114 that is adapted to remove, or strip, cotton from the plant (instead of picking cotton from the plants).

The header system 110 further includes a crop header component that operably harvests a crop from a target field, a hydraulic motor or electric motor (not shown), and one or more sensors. In the illustrated example, the crop header component includes the cotton stripper header 112 configured to strip cotton. For implementations of the header system 110 that include a hydraulic motor, a hydraulic pump on the harvester vehicle 100 can drive the hydraulic motor on the cotton stripper header 112. In these implementations, the hydraulic motor supplies the power to rotate a shaft that drives individual harvesting units, as well as cross augers that deliver cotton to the harvester vehicle 100. In other implementations, the electric motor supplies the power to rotate a shaft that drives individual harvesting units, as well as cross augers that deliver cotton to the harvester vehicle 100.

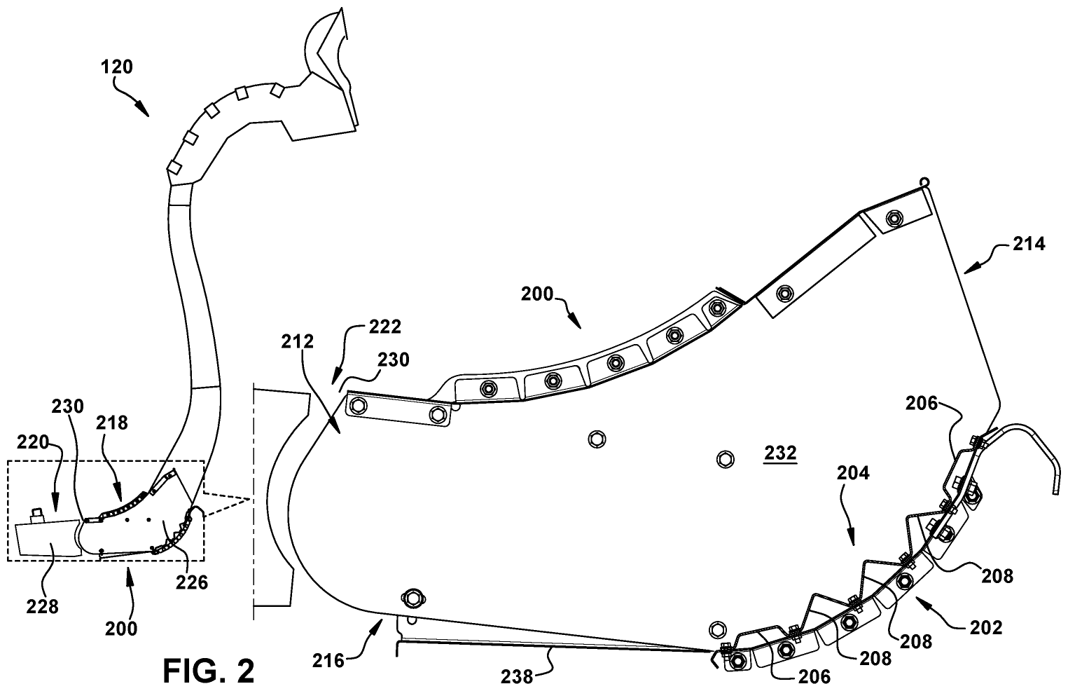

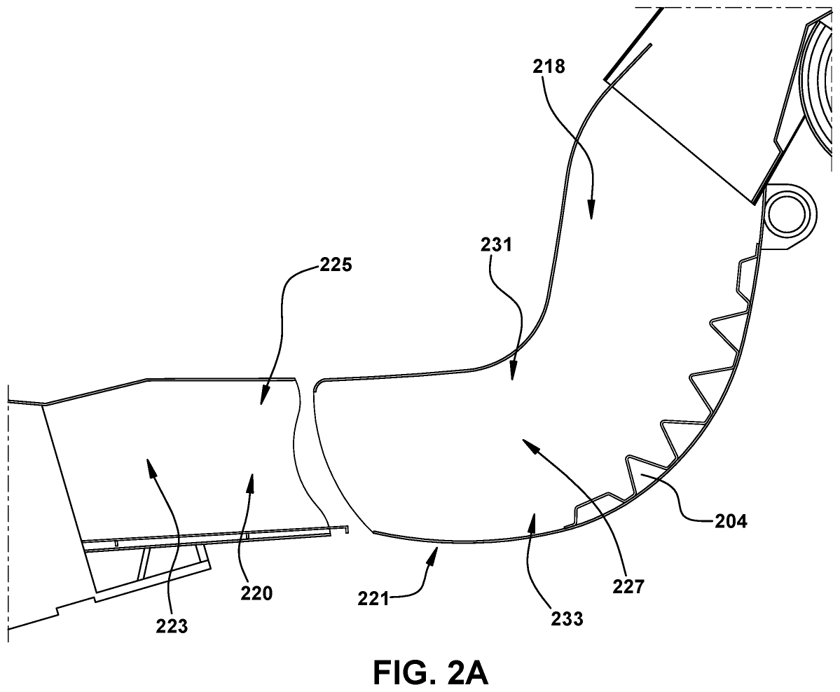

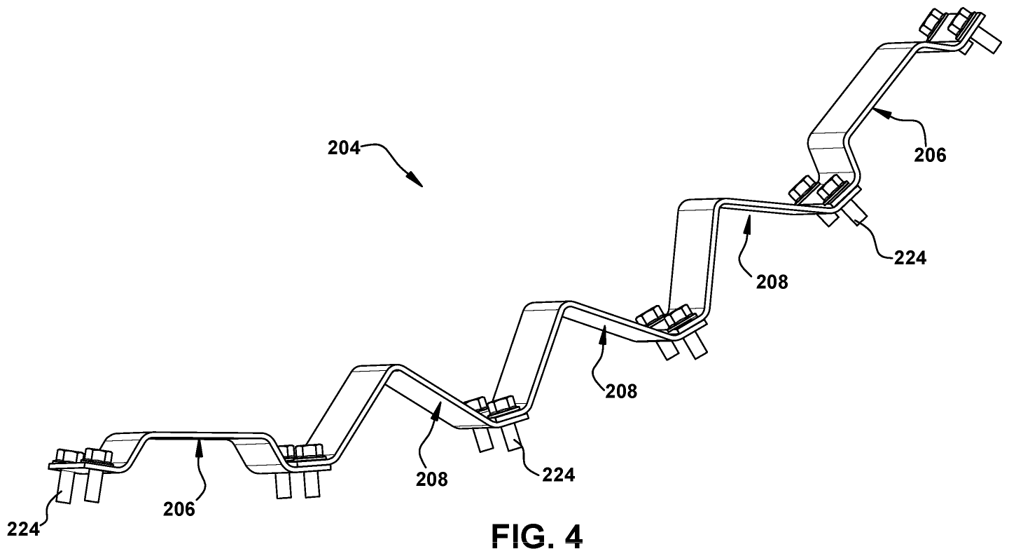

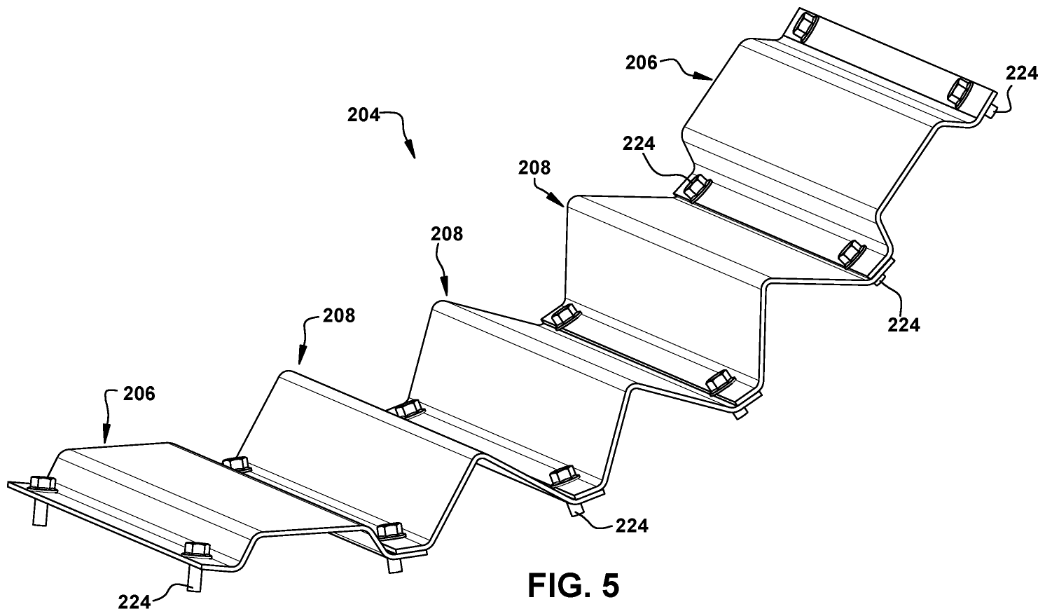

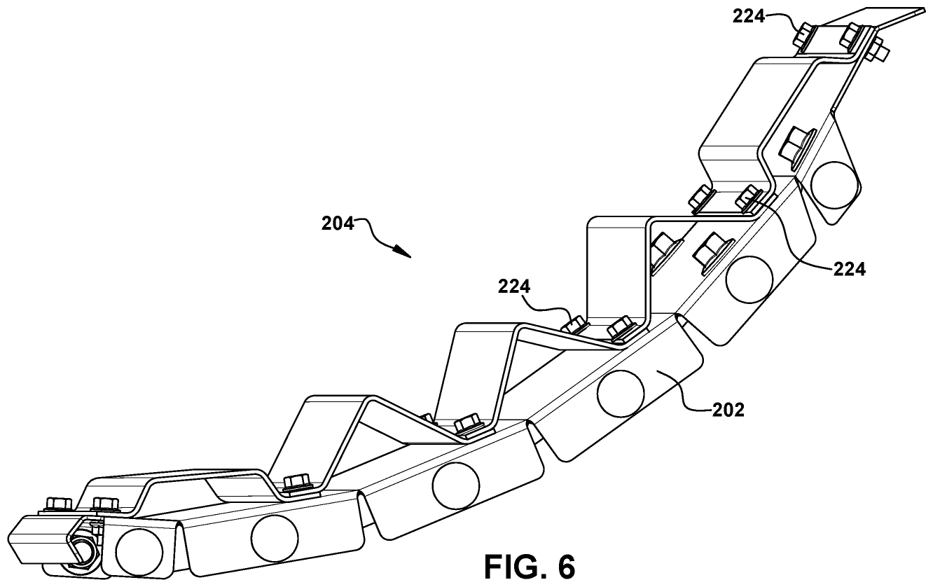

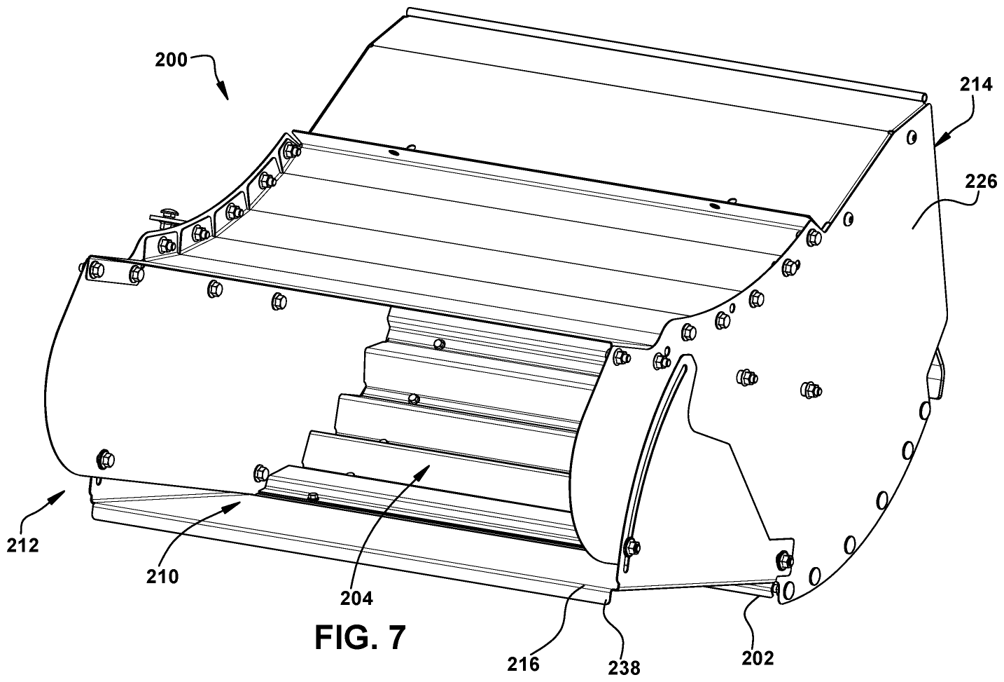

In some implementations, the harvester vehicle 100 includes an air system 120. The air system 120 in some examples includes a crop conveyor component that conveys the crop through the harvester vehicle 100, one or more sensors 160, and a crop conveyor device (e.g., one or more air ducts and an air flow generator). In some implementations as described in more detail herein, the crop conveyor component includes one or more air ducts 122 having a cotton stripper lower transition duct 200 (see FIGS. 2-7) configured to prevent unwanted material from entering the air system 120 when harvesting cotton, and with improved air flow, in particular, an improved cotton mass flow rate during harvesting. That is, one or more examples allow for separation of unwanted material (e.g., separation of green bolls and stones moving up towards the cleaning system) with increased cotton mass flow rate. As such, and for example, user modification to provide more cotton flow is not needed.

In some implementations, the air system 120 is operably coupled to, and in communication with, the header system 110. In these implementations, the air duct 122 is coupled to, and aligned with the cotton stripper header 112, so that the cotton stripped by the cotton stripper header 112 can be transported into the harvester vehicle 100 (e.g., a cleaner) through the air ducts 122 of the air system 120 powered by air flow (e.g., an air generator). One implementation of the air system 120 is shown in FIG. 2, configured as a cotton air flow system having the lower transition duct 200 with improved operation. That is, increased cotton flow is provided while maintaining separation of unwanted or non-desired material.

The one or more sensors 160 can be configured to monitor air flow and/or crop mass flow in the air ducts 122 of the air system 120. In some implementations, one or more of the sensors 160 can be positioned in the air ducts 122. As an example, the harvester vehicle 100, configured as a cotton stripper, includes a plurality of the sensors 160 (e.g., flow sensors) that are mounted across the width of the air ducts 122. In other implementations, one or more of the sensors 160 can be positioned adjacent the air ducts 122. As an example, the harvester vehicle 100, such as the cotton stripper, includes a plurality of mass flow sensors 160 that are mounted behind the air ducts 122 with one cotton mass flow sensor mounted per row unit. The air flow, and/or crop mass flow, can be monitored using various types of sensors.

In some implementations, the harvester vehicle 100 includes a cleaner system 130. In some examples, the cleaner system 130 includes a crop cleaner component that operably cleans the harvested crop, a hydraulic motor or electric motor (not shown), and one or more sensors. In some implementations, the crop cleaner component includes a cleaner 132 that is configured to clean cotton from the cotton stripper header 112 by removing trash and debris. For implementations of the cleaner system 130 that include a hydraulic motor, a hydraulic pump on the harvester vehicle 100 drives the hydraulic motor on the cleaner 132.

In some implementations, the cleaner system 130 is operably coupled to, and in communication with the header system 110 via the air system 120. In these implementations, the cleaner 132 is coupled to, and aligned with, the air duct 122 so that the cotton stripped by the cotton stripper header 112 can be transported into the cleaner 132 through the air ducts 122 of the air system 120 powered by air flow.

A crop receptacle 152 is coupleable to the air system 120 in various implementation. In one or more examples, the crop receptacle 152 is a module builder 150 having at least one baler belt (not shown). As an example, the module builder 150 can be used to build a module of the crop, such as a bale of cotton or hay/straw, etc. In other implementations, the crop may be ejected by the air system 120 into an internal hopper, and/or ejected from the harvester into an accompanying holding tank.

The harvester vehicle 100 further includes an accumulator system 140. The accumulator system 140 in some examples includes a crop accumulator component that operably, temporarily stores the harvested crop. In some implementations, the crop accumulator component includes an accumulator 142. The accumulator 142 is configured to receive cotton, or other crop, harvested by the cotton stripper header 112 or the cotton picking units 116.

In some implementations, the accumulator system 140 is operably coupled to, and in communication with the cleaner system 130. In these implementations, the harvested crop can be transported (e.g., powered by air flow from an air generator) from the cleaner 132 into the top of the accumulator 142 such that the accumulator 142 fills from the bottom up.

In various examples, a feeder 136 is also coupleable to the chassis 108. The feeder 136 can be configured to receive cotton, or other crop, from the accumulator 142. The feeder 136 includes a plurality of rollers configured to compress the cotton, or other crop, and transfer the cotton, or other crop, to the module builder 150 at a feed rate.

With particular reference to FIGS. 2-7, the air system 120 has the lower transition duct 200 that includes a rear separation duct panel 202 having a plurality of protruding members 204 that are configured to separate (e.g., block or prevent) unwanted or non-desired material from passing through the lower transition duct 200 while providing improved cotton mass flow rate. In the illustrated example, the protruding members 204 are baffles configured to deflect, check, or regulate flow or passage of the unwanted or non-desired material (e.g., that is heavier than the wanted material, namely cotton) from within the lower transition duct 200. That is, the protruding members 204 separate the unwanted or non-desired material as the unwanted or non-desired material passes into the lower transition duct 200 by making contact with the unwanted or non-desired material moving along a bottom interior surface of the lower transition duct 200 to thereby prevent the passage of the unwanted or non-desired material as described in more detail herein.

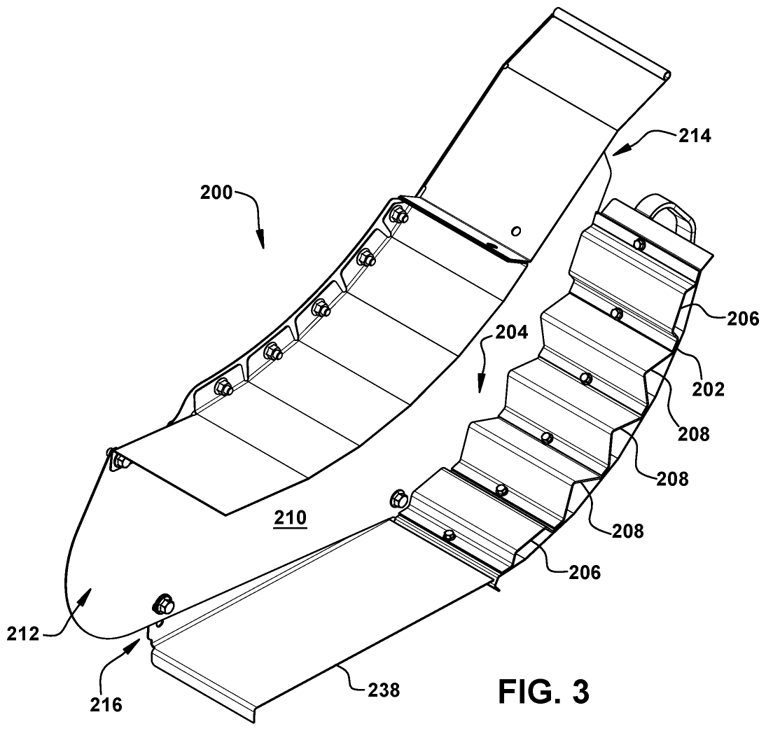

In various implementations, the protruding members 204 include a first type of obstructing members 206 and a second type of obstructing members 208, which in some examples are varying profile height and/or shape baffles. That is, differently configured protruding members 204 are provided along a portion of the lower transition duct 200. In the illustrated example, a first and a last protruding member 204 (e.g., front and rear protruding members 204) have the same configuration (e.g., the first type of obstructing members 206) and the protruding members 204 therebetween have a different configuration (e.g., the second type of obstructing members 208). For example, the first type of obstructing members 206 have a different shape and/or height than the shape and/or height of the second type of obstructing members 208. It should be noted that the number, shape, size, arrangement, etc. of the protruding members 204 can be varied as desired or needed and is not limited to the number, shape, and arrangement illustrated in FIGS. 3-7.

As can be seen, the first type of obstructing members 206 have a generally hat-shaped profile with angled or sloped walls with a raised planar portion therebetween. That is, the first type of obstructing members 206 are configured as hat-shaped baffles. The second type of obstructing members 206 have a generally triangular-shaped profile with angled or sloped walls that meet at a peak. In this example, the peak of the second type of obstructing members 208 extends farther into a passageway 210 (e.g., are taller or have a greater height) through the lower transition duct 200 than the planar surface of the first type of obstructing members 206, while a length of each of the first type of obstructing members 206 extends farther along the surface of the passageway 210 than a length of the second type of obstructing members 208. As such, in this example, the first type of obstructing members 206 are shorter and longer than the second type of obstructing members 208. By increasing a height of the middle protruding members 204 relative to the end protruding members 204 (e.g., having increased height baffles towards the center of the curved path defined by the passageway 210), the configuration separates (e.g., restricts or limits) heavy unwanted or non-desired material without closing the continuous air flow cross-section within the passageway 210.

In some examples, the protruding members 204 are configured to have an incrementally increasing height from a front protruding member 204 to a middle protruding member 204 and then a decreasing height from the middle protruding member 204 to the back protruding member 204. For example, in various examples, the protruding members 204 (e.g., baffles) are configured to increase in height as the depth of the curve increases (e.g., curve of the rear separation duct panel 202) and decrease in height as the depth of the curve decreases or becomes more shallow. This configuration maintains an air flow cross-section while increasing the deceleration ability for foreign material (e.g., unwanted or non-desired materials). It should be appreciated that in various examples, the protruding members 204 can be of any type (e.g., any shape, size, configuration, etc.) and are configured to increase in height into the curve (e.g., curved portion of the duct structure) and decrease leaving the curve. Thus, in various implementations, the protruding members 204 have an increasing and then decreasing height along the travel path of the lower transition duct 200.

It should be noted that the dimensions of the first type of obstructing members 206 and the second type of obstructing members 208 can be modified as desired or needed, such as to have different relative lengths, widths, and heights, as well as different configurations. For example, the first type of obstructing members 206 and/or the second type of obstructing members 208 can be configured having different or varied incrementally increasing or decreasing heights (e.g., different stepwise configurations). It should also be noted that although two of the first type of obstructing members 206 and three of the second type of obstructing members 208 are shown, additional or fewer of the first type of obstructing members 206 and the second type of obstructing members 208 can be provided, and can be arranged in any order to pattern.

In the illustrated example, the second type of obstructing members 208 are positioned adjacent to and abutting the first type of obstructing members 206 of another one of the second type of obstructing members 208. That is, a trailing edge of protruding members 204 abuts a leading edge of an adjacent protruding member 204. However, as should be appreciated, other arrangements and positioning are contemplated. For example, spacing, such as a gap, can be provided between one or more of the protruding members 204 such that the protruding members 204 are provided in a spaced apart arrangement. And, the protruding members 204 can be oriented in different directions than illustrated in FIGS. 3-7, for example, offset or angled from a longitudinal direction and flow path of the passageway 210.

In the illustrated example, the protruding members 204 extend along an entire length of the rear separation duct panel 202. That is, the protruding members 204 extend along an entire length of a lower portion of the passageway 210 of the rear separation duct panel 202. It should be appreciated that the protruding members 204 can extend along a greater or lesser length of the rear separation duct panel 202, as well as along a greater or lesser length of the lower transition duct 200. For example, the protruding members 204 can be provided along higher or lower portions, or more forward or more rearward portions within the passageway 210.

The protruding members 204 in some examples are coupled individually and in series along the rear separation duct panel 202. For example, selective types of the protruding members 204 are separately and individually installed (e.g., coupled with fasteners, illustrated as bolts 224) in series along the rear separation duct panel 202. In some examples, sets of the protruding members 204 are provided and installed along the rear separation duct panel 202 (e.g., sets of protruding members 204 that are integrally formed).

As can be seen, the lower transition duct 200 that includes the rear separation duct panel 202 has a generally continuously curved passageway 210 along a separation area 232 of the lower transition duct 200. That is, in one or more examples, the lower transition duct 200 is configured having the rear separation duct panel 202 that is curved (e.g., having a curved surface) complementary to the curved surface of one or more of the other portions of the lower transition duct 200. As a result, a diameter opening of the lower transition duct 200 is maintained constant throughout at least a portion of the passageway 210, including along the rear separation duct panel 202 where the protruding members 204 are located and the separation of unwanted or non-desired material occurs. This more constant diameter of the passageway 210 allows for more material flow therethrough while still providing removal or separation of unwanted or non-desired material. It should be noted that that the curvature of the rear separation duct panel 202 is configured to have the same curvature as a front or top portion of the lower transition duct 200 on an opposing portion of the passageway 210. It should also be noted that the rear separation duct panel 202 in various examples can have a different curvature than shown, namely, a different slope of the curve that is greater or less than illustrated. In various examples, the rear separation duct panel 202 is configured to be non-planar with a desired or required curvature. In contrast to a lower transition duct having a planar rear separation duct panel and/or with protruding members of all the same type, the lower transition duct 200 provides increased material flow while still removing the unwanted or non-desired material.

The lower transition duct 200 includes an inlet 212 and an outlet 214, wherein the inlet 212 is configured to receive stripped cotton and the outlet 214 is configured to output the stripped cotton with the unwanted or non-desired material removed by the protruding members 204. That is, the protruding members 204 block the unwanted or non-desired material that is then removed from the lower transition duct 200 by the force of gravity. For example, the unwanted or non-desired material is blocked and falls out of an opening 216 at an end of the rear separation duct panel 202. A size of the opening 216 is adjustable using a movable floor portion 238 that in some examples is operable to pivot to change the size of the opening 216. By adjusting the size of the opening 216 (e.g., adjusting a gap in the floor) of the lower transition duct 200 created by the rear separation duct panel 202, different sized material can be removed from the passageway 210 as flow is provided through the lower transition duct 200. That is, heavier unwanted or non-desired material falls back down the passageway 210 and through the opening 216, while lighter stripped cotton that has been harvested continues upward along the passageway 210.

As can be seen, the lower transition duct 200 includes a first portion 218 and a second portion 220. The first and second portions 218, 220 are formed from hollow bodies 226, 228 (e.g., tubular bodies) in some examples that define the passageway 210 therethrough. The second portion 220 is configured as a lower portion that receives inflow of material from an opening (e.g., stripped cotton from a cross-auger). The first portion 218 includes the protruding members 204 and separates the unwanted or non-desired material from the harvested cotton as described in more detail herein.

In the illustrated example, a gap 222 is provided between the first portion 218 and the second portion 220 that allows, in part, movement between the first portion 218 and the second portion 220. In some examples, as can be seen in FIG. 2, a lower portion of the gap 222 is covered or sealed such that no (or a reduced amount of) exposed space is provided between the first portion 218 and the second portion 220. That is, the leading end of the second portion 220 is engaged with the trailing end of the first portion 218 such that only the opening 216 is provided as described in more detail herein. The closing of the gap 222 can be provided in any suitable manner, such as by using a sealing member (e.g., a flexible sealing member 230), extending a length of the second portion 220 towards the first portion 218, etc.

Thus, the lower transition duct 200 has a less restrictive flow through the passageway 210 while still removing unwanted or non-desired material from the harvested cotton. For example, as described in more detail herein, more material flow is provided through the passageway 210 by the geometry of the lower transition duct 200 that includes the differently configured protruding members 204 and/or the curved rear separation duct panel 202. It should be noted that while in some configurations, the curved rear separation duct panel 202 is provided with the differently configured protruding members 204 (e.g., the first type of obstructing members 206 and the second type of obstructing members 208), the curved rear separation duct panel 202 can be provided with protruding members 204 all having the same configuration, or the curved rear separation duct panel 202 can be provided without any protruding members 204. In other configurations, the protruding members 204 that are differently configured are provided with a planar rear separation duct panel 202. In still other configurations, a planar rear separation duct panel 202 is provided without any protruding members 204. As such, it should be appreciated that one or more features described herein can be combined with one or more other features as desired or needed.

In various examples, the geometry of the lower transition duct 200 having the lower transition (separation) duct with curved shape rear separation panel and varying profile height baffles, improves flow rate capacity while separating unwanted or non-desired material. For example, the protruding members 204 with different configurations allow increase flow rate through the passageway 210 while separating unwanted or non-desired material (e.g., provides slowdown and/or restriction of unwanted or non-desired material). A harvester with improved flow (e.g., improved harvesting capacity) is thereby provided, resulting in improved overall operation in some examples.

FIG. 2A is a component diagram illustrating an air flow system with a lower transition duct configured according to an implementation. In any of the implementations, the curved portion of the body is defined by the first and second portions 218, 220 of the air duct. In any of the implementations, the curved portion of the body defines a generally “S” shaped curve 221.

In any of the implementations, the generally “S” shaped curve 221 defined by the first and second portions 218, 220 of the air duct are operable to cause sashay movement of cotton as the cotton moves through the body. In particular and in an example implementation, the generally “S” shape of the air duct is operable to cause sashay movement of cotton as the cotton moves through the body from the lower left to the upper right as viewed in the FIGURE. Cotton generally enters the air duct in the area indicated at 223 in the drawing FIGURE.

In any of the implementations, the generally “S” shaped curve comprises a cotton impingement surface 225. In an example, the cotton impingement surface 225 is defined in areas of the first and second portions of the air duct adjacent to the gap 222 between the first and second portions.

In any of the implementations, the generally “S” shaped curve comprises a velocity gradient zone 227 in an area of the duct near to the plurality of protruding members 204.

In any of the implementations, the velocity gradient zone 207 of the generally “S” shaped curve 221 is operable to induce a higher first traveling velocity in cotton as the cotton moves through the body on a side 231 of the air duct opposite from the plurality of protruding members 204 relative to a second traveling velocity induced in cotton that moves through the body on a side 233 of the air duct that supports the plurality of protruding members.

In any of the implementations, the relative difference between the first and second traveling velocities induced by the velocity gradient zone defines an energy vector oriented in a direction extending away from the plurality of protruding members and generally towards a side of the second portion of the air duct adjacent to the cotton impingement surface.

In any of the implementations, the energy vector defined by the velocity gradient zone enhances separation of cotton from bolls and other debris thereby permitting the cotton to move upward in a first direction through the body on a side of the air duct opposite from the plurality of protruding members while also causing the bolls and other debris to move in a second direction opposite from the first direction on the side of the air duct that supports the plurality of protruding members.

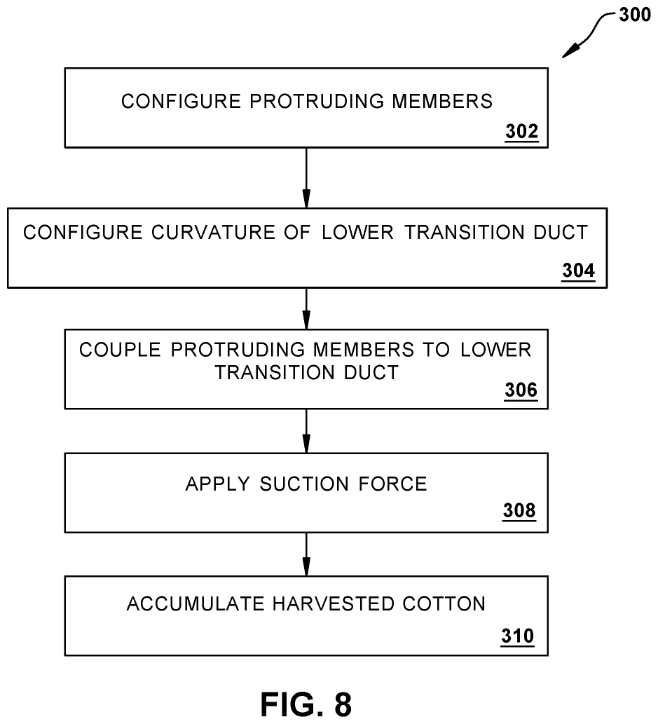

The geometry of the lower transition duct 200 in any of the implementations herein allows more cotton flow while blocking separating unwanted or non-desired material as illustrated in the flowchart 300 of FIG. 8. That is, the flowchart 300 illustrates operations involved in configuring a lower transition duct in a cotton stripper according to one implementation. In some examples, the operations of the flowchart 300 are performed using one or more configurations described in more detail herein.

More particularly, the flowchart 300 commences at 302, which includes configuring a plurality of protruding members to block unwanted or non-desired material while allowing increased flow of cotton. For example, the protruding members 204 are configured to have the first type of obstructing members 206 and the second type of obstructing members 208 that allows for improved flow while blocking the unwanted or non-desired material. In some examples, varying profile height baffles are thereby provided.

At 304, the curvature of the lower transition duct is configured such that a more constant passageway with improved flow therethrough is provided. For example, the rear separation duct panel 202 is curved (instead of being planar) to improve the flow cross-section of the passageway 210 to thereby increase the mass flow rate. In combination with the differently configured protruding members 204, the increased mass flow rate is maintained with effective removal of the unwanted or non-desired material (e.g., stones, green cotton bolls, and other non-desired material).

At 306, the configured plurality of protruding members is coupled to the lower transition duct. For example, the protruding members 204 are bolted to the rear separation duct panel 202 such that the protruding members 204 extend into the passageway 210. In some examples, the protruding members 204 are coupled in a defined arrangement or pattern as described in more detail herein. That is, the protruding members 204 are positioned and bolted to extend into the passageway 210 to allow increased flow while blocking the unwanted or non-desired material. At 308, a suction force is applied to harvest stripped cotton through the lower transition duct. For example, one or more fans are operated to create a suction force that causes the harvested cotton (that includes the unwanted or non-desired material) to pass into the lower transition duct 200, wherein the harvested cotton is accumulated at 310.

Thus, various examples provide improved harvester flow, including increased throughput while removing unwanted or non-desired material. As such, more cotton can be harvested in a shorter period of time with less likelihood of delays due to blockage from the unwanted or non-desired material in various examples.

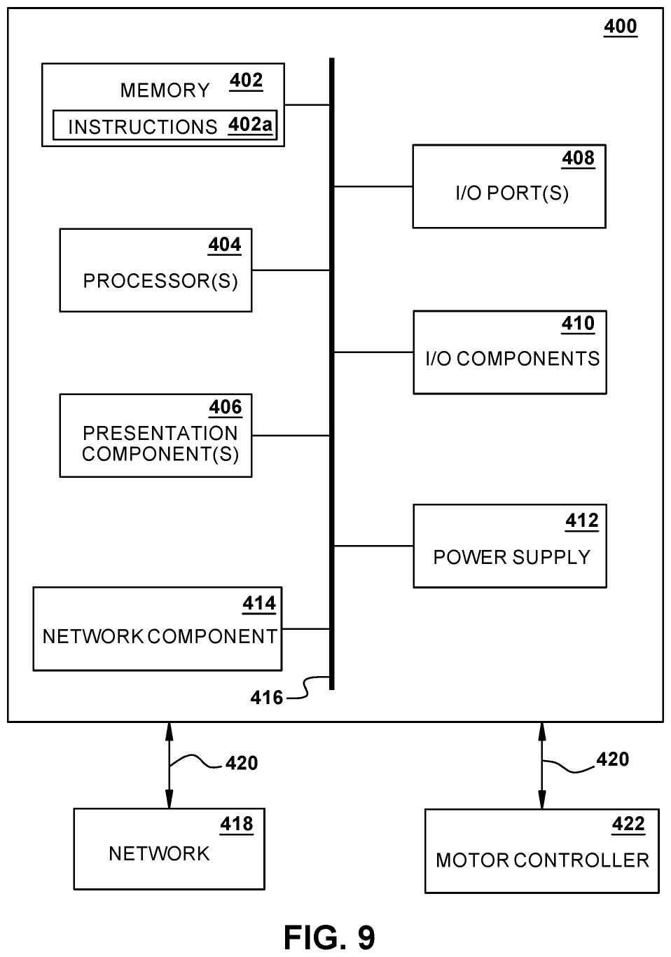

With reference now to FIG. 9, a block diagram of a computing device 400 suitable for implementing various aspects of the disclosure as described (e.g., operations or functions of the operator interface 128 or controller thereof). For example, in operation, the computing device 400 is operable with a motor controller 422 to control operation (e.g., suction force) of one or more motors that cause cotton material to be harvested. FIG. 9 and the following discussion provide a brief, general description of a computing environment in/on which one or more or the implementations of one or more of the methods and/or system set forth herein may be implemented. The operating environment of FIG. 9 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 400 includes a memory 402, one or more processors 404, and one or more presentation components 406. The disclosed examples associated with the computing device 400 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 9 and the references herein to a “computing device.” The disclosed examples are also practiced in distributed computing environments, where tasks are performed by remote-processing devices that are linked through a communications network. Further, while the computing device 400 is depicted as a single device, in one example, multiple computing devices work together and share the depicted device resources. For instance, in one example, the memory 402 is distributed across multiple devices, the processor(s) 404 provided are housed on different devices, and so on.

In one example, the memory 402 includes any of the computer-readable media discussed herein. In one example, the memory 402 is used to store and access instructions 402a configured to carry out the various operations disclosed herein. In some examples, the memory 402 includes computer storage media in the form of volatile and/or nonvolatile memory, removable or non-removable memory, data disks in virtual environments, or a combination thereof. In one example, the processor(s) 404 includes any quantity of processing units that read data from various entities, such as the memory 402 or input/output (I/O) components 410. Specifically, the processor(s) 404 are programmed to execute computer-executable instructions for implementing aspects of the disclosure. In one example, the instructions 402a are performed by the processor 404, by multiple processors within the computing device 400, or by a processor external to the computing device 400. In some examples, the processor(s) 404 are programmed to execute instructions such as those illustrated in the flow charts discussed herein and depicted in the accompanying drawings.

In other implementations, the computing device 400 may include additional features and/or functionality. For example, the computing device 400 may also include additional storage (e.g., removable and/or non-removable) including, but not limited to, magnetic storage, optical storage, and the like. Such additional storage is illustrated in FIG. 9 by the memory 402. In one implementation, computer readable instructions to implement one or more implementations provided herein may be in the memory 402 as described herein. The memory 402 may also store other computer readable instructions to implement an operating system, an application program and the like. Computer readable instructions may be loaded in the memory 402 for execution by the processor(s) 404, for example.

The presentation component(s) 406 present data indications to an operator or to another device. In one example, the presentation components 406 include a display device, speaker, printing component, vibrating component, etc. One skilled in the art will understand and appreciate that computer data is presented in a number of ways, such as visually in a graphical user interface (GUI), audibly through speakers, wirelessly between the computing device 400, across a wired connection, or in other ways. In one example, the presentation component(s) 406 are not used when processes and operations are sufficiently automated that a need for human interaction is lessened or not needed. I/O ports 408 allow the computing device 400 to be logically coupled to other devices including the I/O components 410, some of which is built in. Implementations of the I/O components 410 include, for example but without limitation, a microphone, keyboard, mouse, joystick, pen, game pad, satellite dish, scanner, printer, wireless device, camera, etc.

The computing device 400 includes a bus 416 that directly or indirectly couples the following devices: the memory 402, the one or more processors 404, the one or more presentation components 406, the input/output (I/O) ports 408, the I/O components 410, a power supply 412, and a network component 414. The computing device 400 should not be interpreted as having any dependency or requirement related to any single component or combination of components illustrated therein. The bus 416 represents one or more busses (such as an address bus, data bus, or a combination thereof). Although the various blocks of FIG. 9 are shown with lines for the sake of clarity, some implementations blur functionality over various different components described herein.

The components of the computing device 400 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 400 may be interconnected by a network. For example, the memory 402 may be comprised of multiple physical memory units located in different physical locations interconnected by a network.

In some examples, the computing device 400 is communicatively coupled to a network 418 using the network component 414. In some examples, the network component 414 includes a network interface card and/or computer-executable instructions (e.g., a driver) for operating the network interface card. In one example, communication between the computing device 400 and other devices occurs using any protocol or mechanism over a wired or wireless connection 420. In some examples, the network component 414 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 420 may include, but is not limited to, a modem, a Network Interface Card (NIC), an integrated network interface, a radio frequency transmitter/receiver, an infrared port, a USB connection or other interfaces for connecting the computing device 400 to other computing devices. The connection 420 may transmit and/or receive communication media.

Although described in connection with the computing device 400, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or carphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An air duct for a cotton stripper, the air duct comprising:
a body having a passageway therethrough, wherein the body has a curved portion; and
a plurality of protruding members extending into the passageway, wherein the plurality of protruding members comprises a first type of obstructing members and a second type of obstructing members, the first type being different than the second type,
wherein the plurality of protruding members extend along the curved portion of the body.

2. The air duct of claim 1, wherein a first protruding member and a last protruding member of the plurality of protruding members are of the first type of obstructing member and all of the protruding members between the first and last protruding members are of the second type of obstructing member.

3. The air duct of claim 2, wherein the second type of obstructing member has a height that is greater than a height of the first type of obstructing member.

4. The air duct of claim 1, wherein the first type of obstructing members comprises hat-shaped baffles.

5. The air duct of claim 1, wherein the second type of obstructing members comprises triangular-shaped baffles.

6. The air duct of claim 1, wherein the first type of obstructing members having a first profile height and the second type of obstructing members have a second profile height, wherein the first profile height is different than the second profile height.

7. The air duct of claim 1, wherein the plurality of protruding members comprises baffles of varying profile heights.

8. The air duct of claim 1, wherein the curved portion of the body comprises a curved rear separation duct panel and the plurality of protruding members are configured to increase in height as a depth of the curved rear separation duct panel increases and decrease in height as the depth of the curved rear separation duct panel decreases.

9. The air duct of claim 1, further comprising a first portion formed from the body and a second portion formed from another body, the first and second bodies having complementary passageways, wherein the first portion is coupled to the second portion having a gap therebetween.

10. The air duct of claim 9, wherein:
the curved portion of the body defines a generally “S” shaped curve that is operable to cause sashay movement of cotton as the cotton moves through the body,
wherein the generally “S” shaped curve comprises a cotton impingement surface defined in areas of the first and second portions of the air duct adjacent to the gap between the first and second portions,
wherein the generally “S” shaped curve comprises a velocity gradient zone in an area of the duct near to the plurality of protruding members

11. The air duct of claim 1, wherein each member of the plurality of protruding members abuts at least one adjacent member of the plurality of protruding members.

12. The air duct of claim 1, wherein each member of the plurality of protruding members is spaced apart from at least one adjacent member of the plurality of protruding members.

13. The air duct of claim 1, wherein the body is configured to couple with a cross-auger of a cotton stripper.

14. A harvester vehicle comprising:
a header system that includes a crop header component, wherein the crop header components comprises a cotton stripper header; and
an air system operably coupled to, and in communication with, the header system, the air system comprising a crop conveyor component that conveys crop through the harvester vehicle, wherein the crop conveyor component includes one or more air ducts having a cotton stripper lower transition duct comprising a curved rear separation panel with a plurality of varying profile height baffles.

15. The harvester vehicle of claim 14, wherein the plurality of varying profile height baffles comprises baffles having different shapes, including a plurality of a first type of obstructing members and a plurality of a second type of obstructing members.

16. The harvester vehicle of claim 14, wherein the plurality of varying profile height baffles comprises hat-shaped obstructing members.

17. The harvester vehicle of claim 14, wherein the plurality of varying profile height baffles comprises triangular-shaped obstructing members.

18. The harvester vehicle of claim 14, wherein the plurality of varying profile height baffles are configured in an abutting arrangement.

19. The harvester vehicle of claim 14, wherein the plurality of varying profile height baffles are configured in a spaced apart arrangement.

20. A method for configuring a lower transition duct in a cotton stripper, the method comprising:
configuring a plurality of protruding members to having a first type of obstructing member and a second type of obstructing member;
configuring a rear separation duct panel of the lower transition duct to have a curved surface; and
coupling the plurality of protruding members to the curved surface of the rear separation duct panel, wherein the protruding members extend into a passageway of the lower transition duct.
